(19) United States
(12) Patent Application Publication
(10) Pub. No.: US 2012/0278998 A1
(43) Pub. Date: Nov. 8, 2012

(54) Fix A Flop Sandal Patches

(76) Inventor: Nicole Charleste Thomas, Evans, GA (US)

(21) Appl. No.: 13/049,057

(22) Filed: May 4, 2011

(51) Int. Cl. B32B 43/00; B32B 3/02; B32B 3/10; A43D 95/00; A43B 3/12

(52) U.S. Cl. 12/142 Q; 428/131; 428/66.6

(57) ABSTRACT

Discovery of an improved method in mending the overexposed hole when the plastic flip flop strap anchor has separated completely from the rubber sole. What is referenced to as a “patch,” is put on in a “buttoning” manner. The patch has an adhesive that has a protective cover. Before the patch is applied, the protective cover should be peeled completely to expose the adhesive. With the adhesive facing the bottom sole of the flip flop, button the patch on to the plastic anchor and secure the adhesive against the sole of the flip flop sandal. The mend is permanent, fun, colorful, creative, and 100% environmentally recyclable. This method also adds extra cushion. Foam rubber flip flops wear over time, condensing the foam rubber and exposing the plastic “knobs” that are behind the arch of the foot.

When the Fix A Flop Sandal Patch was created, a sharp punch for cutting the 3/32″ thick rubber in a ⅞″ circle shape, or a square shape that is one square inch was used. Using a second oblong punch, a hole is made, generally centrally located. Generally, the Sandal Patch has an adhesive on one side that has a protective strip that is peeled off before applying the patch. To apply the Sandal Patch to the sole of the flip flop, simply, in a buttoning fashion, button the patch onto the plastic anchor knob, securing the adhesive against the sole of the sandal, completely preventing and/or fixing what is known as a ‘Flip-Flop Blowout.’ The Sandal Patch can also be placed at the two plastic anchor knobs located behind the arch of the foot. Place a Sandal Patch onto the back two plastic knobs in the same buttoning fashion, securing the adhesive to the sole of the sandal, now adding extra cushion and comfort if the sandal sole thins and wears from normal wear. There are a hundreds of possibilities when creating Sandal Patches in different designs, colors, shapes, symbols, and characters. Not only does the Sandal Patch fix and/or prevent the problem of a Flip-Flop Blowout, adding safety, but it also adds comfort, fun and an opportunity for individuality and self-expression in every patch when made in the full potential of the Sandal Patch invention. The idea of Fix A Flop Sandal Patches is to have 100% product and packaging and many ways to be involved in Green projects. The goal is to find a partner in Newell, Rubbermaid.

### DETAILED DESCRIPTION OF THE DRAWINGS

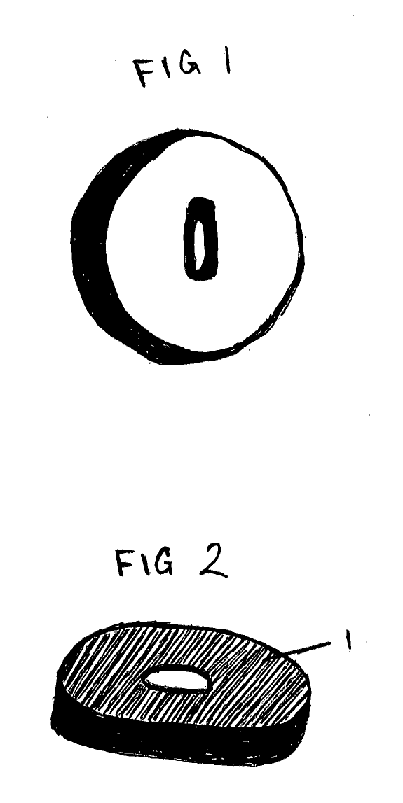

FIG. 1 illustrates the Sandal Patch with an exaggerated scale. It is the front view of a patch cut in a circle also having an oblong central hole for ‘buttoning’ the patch onto the sole of a flip flop sandal.

FIG. 2 illustrates the Sandal Patch as if it is laying on a flat surface, with the adhesive side facing upward, 1. The adhesive, 1, covers the entire surface of one side of the Sandal Patch.

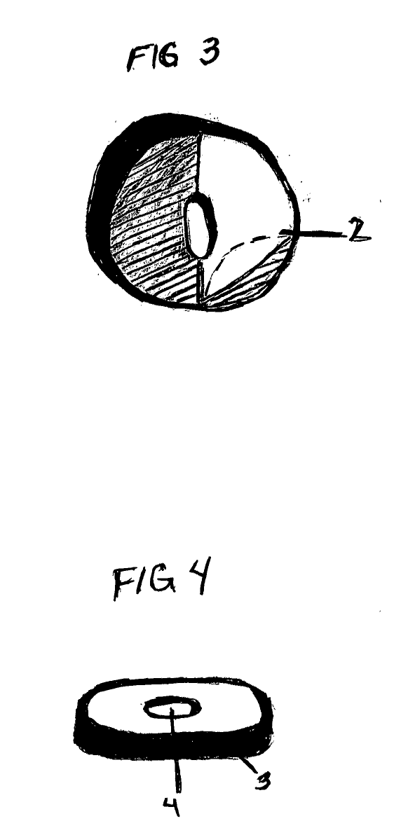

FIG. 3 illustrates the Sandal Patch facing forward, exposing the adhesive on one side and the other half illustrates the basic protective covering, 2, that is peeled before applied to the sole of the flip flop sandal. The protective covering protects the entire surface with adhesive, drawing half of the protective covering is for illustration purposes only.

FIG. 4 illustrates the Sandal Patch as if it is laying on a flat surface, facing upward. The shaded area, 3, illustrates the thickness of the Sandal Patch, which generally is 3/32″-¼″ thick. Thickness may vary depending on the rubber used and design of the Sandal Patch. There is a non-specific opening, 4, cut in every piece of rubber, usually centrally located and ⅛″× 7/16″ in dimension.

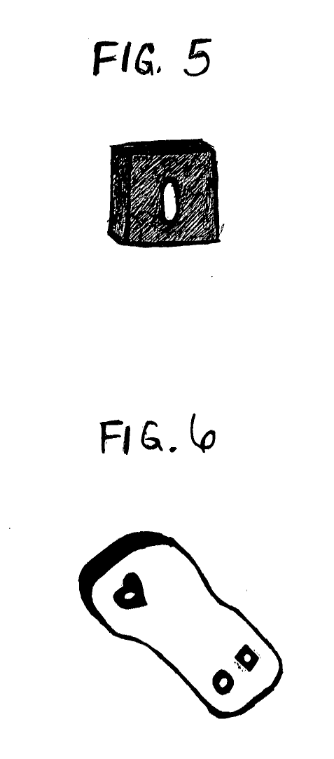

FIG. 5 illustrates the Sandal Patch in a basic square shape, with an oblong central opening.

FIG. 6 illustrates three different Sandal Patches, placed on all three plastic “knobs” designed to be anchor at the bottom sole of the flip flop sandal, keeping the sandal secure on the foot.

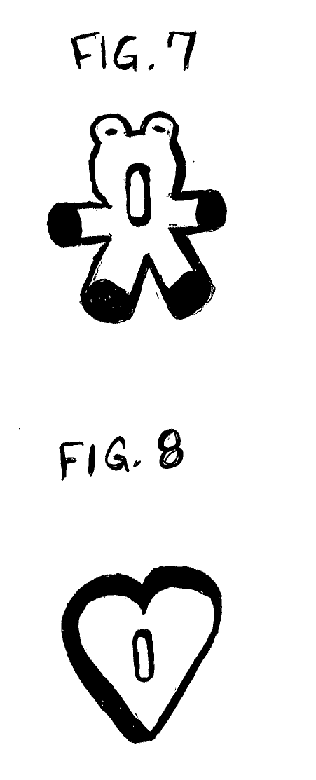

FIG. 7 illustrates the Sandal Patch cut into an animal shape, with an oblong central opening.

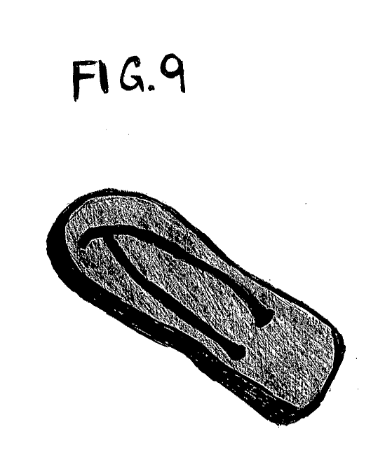

FIG. 8 illustrates the Sandal Patch cut into a symbol, with an oblong central opening.

FIG. 9 illustrates the style of flip flop sandal where the Fix A Flop Sandal Patch can be used.

FIGS. 1, 2, 3, 4, 5, 6, and 9 were illustrated on new sheets, attempting to make illustrations easier to interpret. FIGS. 7 and 8 (original page 4 of drawings) were omitted due to seeming redundant. FIGS. 7 and 8 were replaced by a New Sheet that illustrates a couple of the many potential shapes of a Sandal Patch.

A single Fix A Flop Sandal Patch adds safety if applied before the Flip-Flop Blowout, a repair for after a Flip-Flop Blowout, as well as added comfort, individuality and colors. Basic black rubber is the most basic style Sandal Patch.

1. The Fix A Flop Sandal Patch is an improved way to repair a sandal having a thong attachment that is secured in a sandal sole, usually made with rubber foam—also known as a Flip Flop Sandal. The patch is around ¾″, depending on the shape and design and about 3/32″ thick. Each patch has a non-specific opening where the patch is placed (as if buttoning) onto the thong attachment that extends through the big and second toe. There is an adhesive that secures the patch onto the sole of the sandal, securing the thong into place, keeping the sandal in-tact.

2. The Fix A Flop Sandal Patch is an improved way to repair a sandal having a thong attachment In accordance with claim 1, wherein the patch is generally circular in shape.

3. The Fix A flop Sandal Path is an improved way to repair a sandal having a thong attachment in accordance with claim 2, wherein the patch is generally square in shape.

4. The Fix A Flop Sandal Patch is an improved way to repair a sandal having a thong attachment In accordance with claims 2 and 3, wherein the patch size may vary.

5. The Fix A Flop Sandal Patch is an improved way to repair a sandal having a thong attachment In accordance with claims 2 and 3, wherein the patch shape may vary.

6. The Fix A Flop Sandal Patch is an improved way to repair a sandal having a thong attachment In accordance with claims 2 and 3, wherein the patch color(s) may vary.

7. The Fix A Flop Sandal Patch is an improved way to repair a sandal having a thong attachment In accordance with claim 6, wherein the patch has a non-specific opening.

8. The Fix A Flop Sandal Patch is an improved way to repair a sandal having a thong attachment in accordance with claim 7, where the non-specific opening usually placed centrally.

9. The Fix A Flop Sandal Patch is an improved way to repair a sandal having a thong attachment In accordance with claim 8, wherein the non-specific opening may take on different designs.

10. The Fix A Flop Sandal Patch is an improved way to repair a sandal having a thong attachment in accordance with claim 9, where the patch has an adhesive that has a protective layer that is peeled back when ready to place patch onto the sole of the sandal.

11. The Fix A Flop Sandal Patch is an improved way to repair a sandal having a thong attachment in accordance with claim 10, where the adhesive mends the sole, allowing the flip flop sandal to be fully functional and safe.

12. The Fix A Flop Sandal Patch is an improved way to repair a sandal having a thong attachment in accordance with claim 11, wherein the patch is generally made of rubber with a particular durometer.

13. The Fix A Flop Sandal Patch is an improved way to repair a sandal having a thong attachment in accordance with claim 12, where it is a process to add comfort to the sandal wearer by placing a single patch onto the sole of the flip flop at the two plastic anchors located behind the arch of foot when foot is placed in the flip flop sandal.

14. The Fix A Flop Sandal Patch is an improved way to repair a sandal having a thong attachment in accordance with claim 13, where more than one patch can be placed onto the sole of the flip flop.

15. The Fix A Flop Sandal Patch is an improved way to repair a sandal having a thong attachment in accordance with claim 14, where the patch adds a pleasing aesthetic style to the sole of the sandal, keeping the consumer in mind.

16. The Fix A Flop Sandal Patch is an improved way to repair a sandal having a thong attachment in accordance with claim 15, where the consumer is kept in mind when designing the patch, maintaining a flat 2D flat shape, normally about 3/32″ thick and can range for easy transport in swimwear, undergarments, and any other form of transport.

17. The Fix A Flop Sandal Patch is an improved way to repair a sandal having a thong attachment in accordance with claim 16, where the consumer is kept in mind when designing the patch, where the flat 2D flat shape can range in thickness depending on the patch application (e.g. if buttoning the patch onto the back two plastic anchors located behind the heel of the foot.)

18. A method to add comfort to the sandal wearer in accordance with claim 17, lifting the condensed sole for added comfort, where also an increase in the thickness of the patch may be desired.

19. An improved way to repair a sandal having a thong attachment in accordance with claim 18, where the shape, color, and/or design of the sandal patch resembles a symbol—not necessarily using the common represented colors—used and seen in our everyday environment (e.g. snowflake, any type of ball used for sport/athletics, sun, triangle, hexagon, star, heart, diamond, apple, etc.)

20. An improved way to repair a sandal having a thong attachment in accordance with claim 19, where the product and packaging is 100% recyclable, keeping the earth and consumer in mind.
